(19) United States
(12) Patent Application Publication
(10) Pub. No.: US 2021/0362256 A1
(43) Pub. Date: Nov. 25, 2021

(54) Method and apparatus for sharpening a saw chain

(71) Applicant: Fomatec Oy, Kuopio (FI)

(72) Inventor: Marko Korhonen, Kuopio (FI)

(21) Appl. No.: 17/256,666

(22) PCT Filed: Jun. 29, 2018
(86) PCT No.: PCT/FI2018/050521

§ 371 Date: Dec. 29, 2020

(51) Int. Cl. B23D 63/16

(52) U.S. Cl. CPC B23D 63/16

(57) ABSTRACT

What is disclosed is a new type of method and device for sharpening the saw chain of a chain saw. In the first stage of the method, a rotating sharpener is brought against the first cutter to be sharpened of the chain and the sharpener is pressed against the first cutter at a set sharpening angle in order to remove material from the cutting edge of the first cutter. The chain is then moved in its longitudinal direction to position the second cutter for sharpening. In the second stage, the rotating sharpener is kept rotating in the same direction as in the first stage and the rotating sharpener is brought at a set sharpening angle against the second cutter to be sharpened in order to remove material from the cutting edge of the second cutter.

### FIELD OF TECHNOLOGY

The present invention relates to the maintenance and sharpening of the chains of saw devices used in forest machines and similar devices. In particular, the invention relates to the automatic sharpening of the saw chains of forest machines.

### BACKGROUND

The user of the saw chains of manually-operated chain saws generally sharpens them manually at the work site when necessary. However, the need to replace the saw chains of timber harvesters and similar forest machines equipped with chain saws is so great that manual sharpening is not sensible. Mechanical sharpening also produces a sharpening result of more even quality than manual sharpening. Therefore, machine contractors keep a sufficient number of chains, for example for a month, and the worn chains are taken at regular intervals to a sharpening service for sharpening. The sharpening service inspects the chain for damage, sharpens the cutters of the chain, and decreases the length of the depth gauge as required. The chain is inspected by an operator, who examines the entire length of a chain and moves the chain to sharpening, repair, or scrapping.

The sharpening devices presently in use are semi-automatic. The chain to be sharpened is set in them by hand and the operator sets the grinding disc grinding the cutters and the possible grinding disc grinding the depth gauge to the correct angle and cutting depth, after which the device carries out the sharpening work automatically. In this work cycle, changing the chains by hand and adjusting the grinding discs takes time and reduces productivity. Because the grinding disc wears in use, the machine operator must take this into account when making the settings. Also wear cannot be taken into account during sharpening.

### SUMMARY

The present invention is intended to create a method for sharpening a saw chain, and a sharpening device, by which chain sharpening is made more efficient.

The invention is characterized by what is stated in the characterizing portions of the independent Claims.

According to the first feature of the invention, in the first sharpening stage a rotating sharpener is brought against the first cutter to be sharpened of the chain and the sharpener is pressed against the first cutter at the set sharpening angle to remove material from the cutting edge of the first cutter. Next, the chain is moved in the direction of its longitudinal axis to position the second cutter for sharpening. In the second stage, the rotating sharpener is kept rotating in the same direction as in the first stage and the rotating sharpener is brought at the set sharpening angle against the second cutter to be sharpened to remove material from the cutting edge of the second cutter.

According to the second feature of the invention, the rotating sharpener is a grinding disc, which is rotated in the same direction during the sharpening of at least two teeth, and the saw chain is moved in the direction of its longitudinal axis and the grinding disc is adjusted to the set sharpening angle so that the grinding disc extends over the chain at an angle and the grinding disc is turned to sharpen the second cutter, in such a way that the edge of the grinding disc on the incoming direction of the chain turns over the chain to the other side of the chain to the incoming-direction side of the chain.

According to the third feature of the invention, on each side of the saw chain, relative to its longitudinal direction is a sharpener, which sharpens the cutters on the same side as the sharpener.

According to the fourth feature of the invention, the sharpeners on each side of the saw chain are grinding discs.

According to the fifth feature of the invention, at least one of the sharpeners is a round file.

According to the sixth feature of the invention, there is a measuring device in the sharpening device for measuring the diameter of the grinding disc.

According to the seventh feature of the invention, there are two vice jaws in the sharpening device, moving relative to each other, between which the saw chain can be clamped.

According to the eighth feature of the invention, the sharpening device has a shaping tool for shaping the working surface of the grinding disc.

According to the ninth feature of the invention, the saw chains are placed in the sharpening device by a robot.

### BRIEF DESCRIPTION OF THE DRAWINGS

In the following, some embodiments of the invention are described in greater detail with reference to the accompanying drawings, in which:

FIG. 1 shows a diagrammatic perspective view of a saw chain,

FIG. 2 shows a perspective view of the sharpening device of a device according to at least one embodiment, in the first sharpening attitude, from the first side of the chain,

FIG. 3 shows the device of FIG. 2 in the second sharpening attitude,

FIG. 4 shows the device and attitude of FIG. 2 from the opposite side of the chain,

FIG. 5 shows the device and attitude of FIG. 3 from the opposite side of the chain,

FIG. 6 shows the chain centring device used in a device according to at least one embodiment,

FIG. 7 shows the grinding-disc measuring device used in a device according to at least one embodiment, and

FIG. 8 shows the aligner used in a device according to at least one embodiment.

### EMBODIMENTS

### Definitions

In this context, the term incoming direction of the saw chain refers to the direction in the longitudinal axis of the chain, in which the cutting edge of the cutting tooth points, i.e. the direction of movement of the chain when it cuts.

The invention is intended to boost the maintenance cycle of saw chains used in chain saws. The sharpening of chains is an important part of their maintenance, so that by accelerating sharpening and improving the quality of the work, and by automating the sharpening a significant improvement can be made in different stages of the maintenance cycle. The use of various embodiments of the invention will improve the efficiency and quality aspects of at least one or possibly several stages of sharpening work. During sharpening, the direction of rotation of the rotating sharpener is maintained and does not change between the sharpening of at least two consecutive cutters sharpened with the same sharpener. As the direction of rotation of the sharpener is kept the same, the braking and acceleration required by changes in rotation direction are eliminated, thus reducing the stage time. Particularly in embodiments, in which a grinding disc is used as the sharpener, disc durability improves, because stresses caused by acceleration, braking, and changes in the direction of the cutting resistance are reduced.

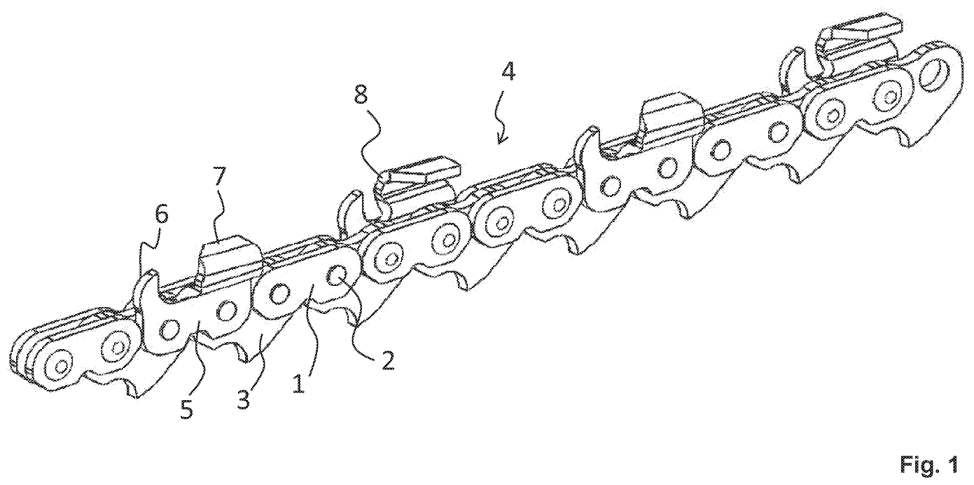

FIG. 1 shows an example of a typical saw chain of a chain saw. The saw chain 4 is formed by tie straps 1 and drive links 3, which are joined together by rivets 2 to form the chain. The longitudinal axis of the saw chain 4 runs at the centre point between the tie straps 1. On both sides of the chain 4 are cutting plates 5. The cutting plates 5 replace the tie straps 1 at regular intervals on both sides of the chain 4. In the cutting plates 5 there is a depth gauge 6, which protrudes upwards from the outer surface of the chain 4 and at a distance from the depth gauge 6 there is a similarly upwardly protruding cutter 7. In the front edge of the cutter 7 is a cutting edge 8, which thus determines the chain's direction of travel and the direction of cutting. The depth gauge 6 comes first in the direction of travel of the chain and is intended to run along the bottom of the chain saw's cutting groove. The height of the depth gauge 6 determines how much of the cutting edge 8 on the front edge of the cutter 7 is exposed behind the depth gauge 6 in the direction of travel of the chain. This determines the cutting depth of the chain's 4 cutters 7. When the chain is sharpened, the cutter's 7 cutting edge 8 is ground enough to be definitely sharp. Too little grinding leaves the cutter blunt and too much reduces the service life of the chain. During the grinding of the cutter 7, the height of the depth gauge is also suitably reduced.

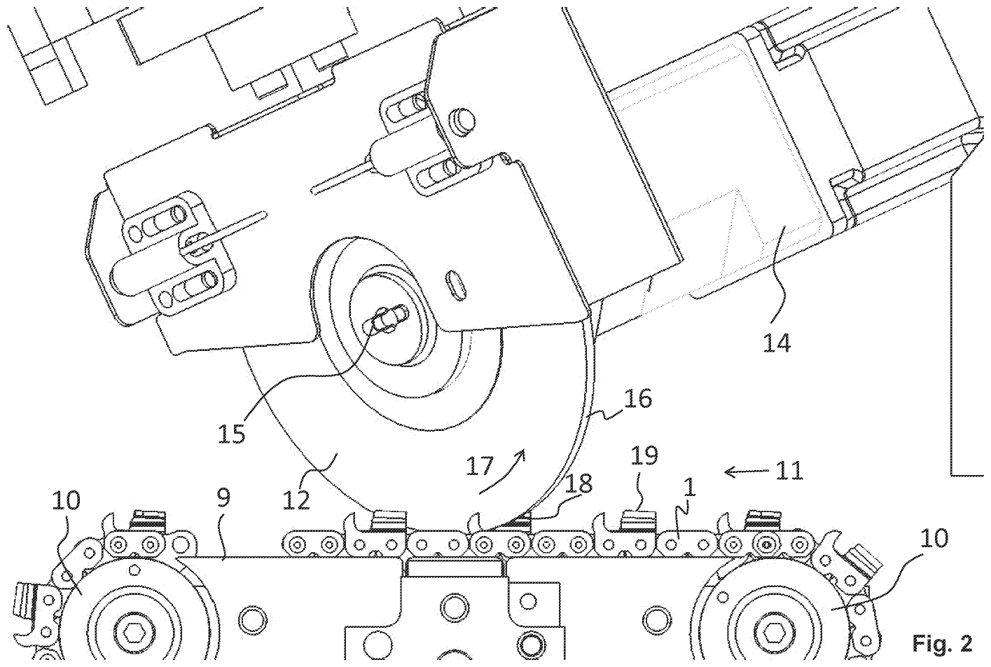

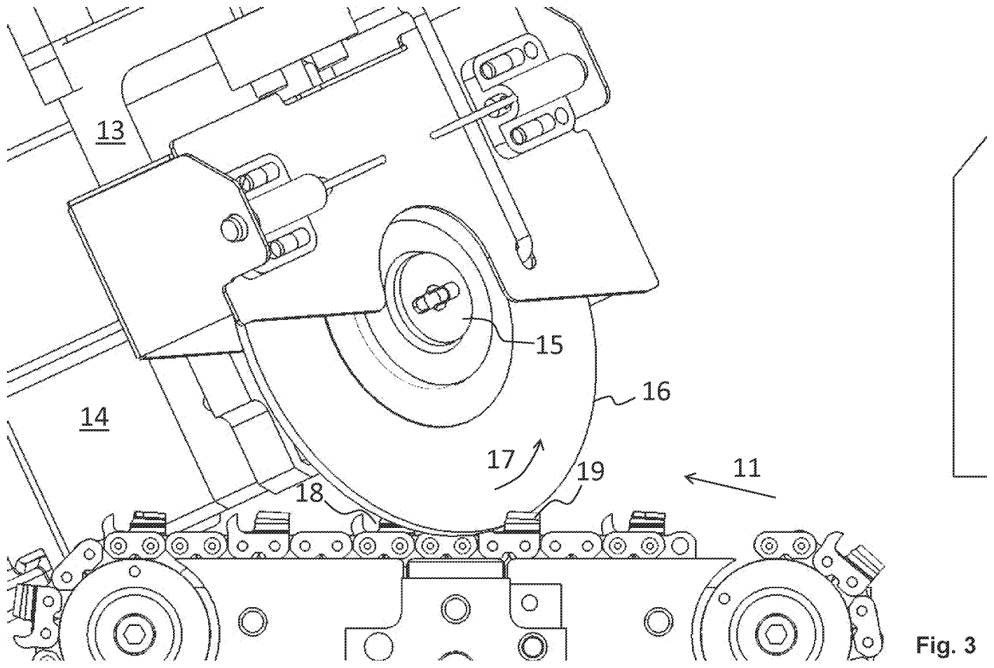

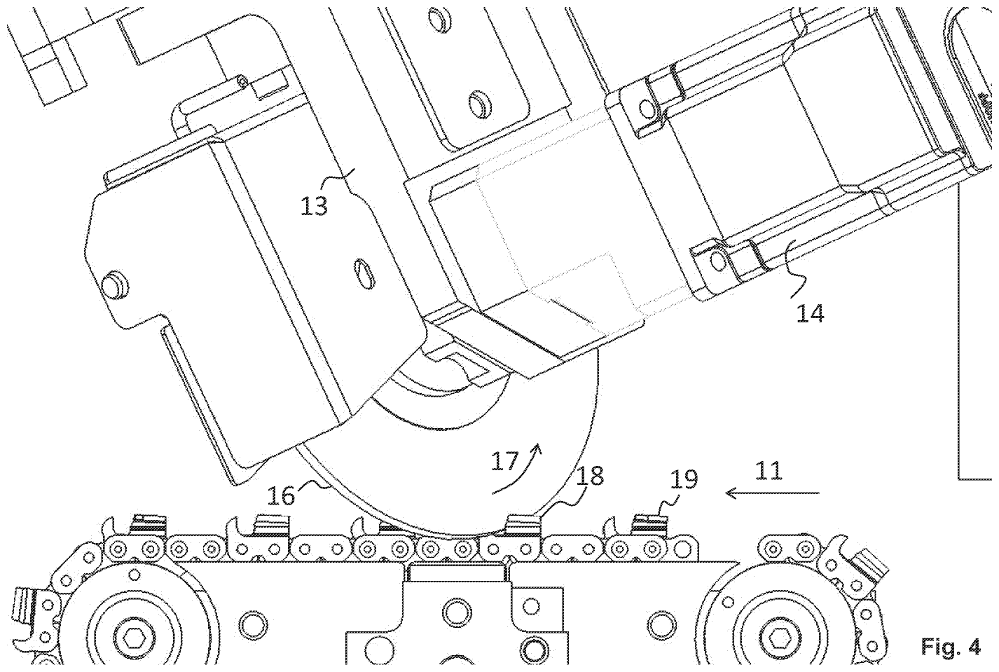

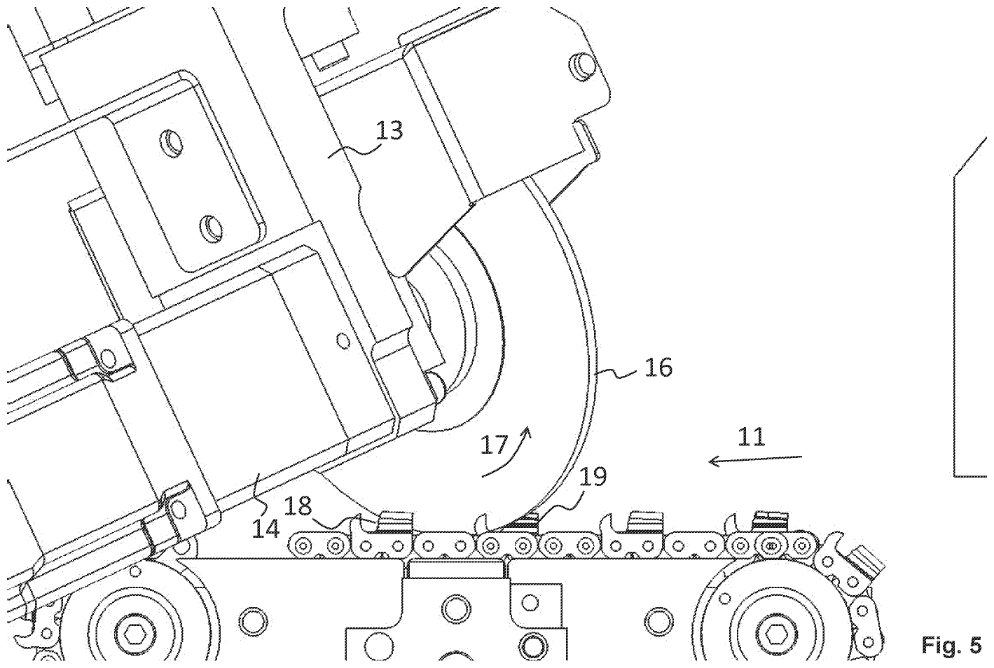

FIG. 2 shows a sharpening device, in which a saw chain 4 is placed for sharpening. FIGS. 2-5 show only the parts of the device relating to sharpening a cutter. It is obvious that, for example, an automatic sharpening device or machine will include normal frame parts, guard devices, cabinets, and similar. These are not shown here. For example, one skilled in the art of metal-machining equipment will understand what accessories, safety device, and similar a machine or device of this kind will require.

In the device of FIGS. 2-5, the saw chain 4 is arranged to run through idlers on the sharpening table 9. There can be grooves for the guide flanges of the drive links 3 in the idlers 10 and the sharpening table 9. Thus the chain 4 is supported in the same way as in the groove of the guide bar of a chain saw. The chain 4 is moved forward between the idlers 10 under tension, a step at a time. The direction of movement of the chain 4 is shown by the direction arrow 11 of the chain. Here the sharpener is a grinding disc 12, which is shown in FIGS. 2-5 in sharpening positions against the cutter 7. The grinding disc 12 is rotated in the direction of the rotation-direction arrow 17. The grinding disc 12 must be set at the correct angle to the cutter to be sharpened of the chain 4 on the sharpening table 9. This angle depends on the type of chain and the attitude of the grinding disc and the sharpening angle of the cutter arising as a result is set by adjusting the attitude of the grinding disc 12. The grinding disc 12 is attached to a movement arm 13, which moves the grinding disc 12 in the direction of the cutter 7 to be sharpened, and adjusts the angle of the grinding disc 12 relative to the longitudinal axis of the chain 1 and relative to the longitudinal axis in the transverse direction. In addition, the movement arm is used to rotate the grinding disc around the axis of the movement arm 13, in order to rotate the grinding disc 12, to machine the cutters 7 on both sides of the chain. The rotational movement of the grinding disc 12 is implemented by a motor unit 14. The motor unit 14 is attached to the movement arm 13 and the grinding disc 12 is attached to its shaft 15. The motor unit can be any device assembly whatever permitting a sufficient speed of rotation, torque, and adjustability. One alternative are various electric-motor drives, which can include an electric motor, its control units, and, if necessary, a gearbox.

The sharpening of a saw chain using a device according to FIGS. 2-5 takes place by first of all placing the chain 4 on the idlers 10 and sharpening table 9 and tightening it in place. Because saw chains 4 are closed loops when being sharpened, the locking of the chain 4 can be done simply by, for instance, tightening using a third movable idler. The chain 4 is thus reliably attached to the device and can be moved in the direction of its longitudinal axis. The chain 4 can be installed in the sharpening device by hand, partly automatically, or fully automatically, for instance, by robots. A service robot, which sets the chain in place for sharpening and removes the sharpened chain, is highly suitable for use with the method and device according to the invention. Both of these stages, or only one of them can be automated using the said robot or robots, or some other automatic manipulator. A robot has the advantage of operational variability and flexibility by altering its programming and control. The chain is locked in place for sharpening in the manner described hereinafter. The cutter to be sharpened must be positioned in such a way that the machining edge 16 of the grinding disc 12 strikes the edge of the cutter during the machining movement in such a way as to machine precisely the correctly sized part of the edge of the cutter 7, in order to sharpen the cutter 7. The chain 4 can be moved in the direction of the its longitudinal axis, for example, by using one or more idlers as a drive wheel, or by gripping the chain 4 and moving it forwards or backwards in steps. To detect the correct location of the cutter to be sharpened, the control data of the device's control system, mechanical sensors, optical sensors, or even machine-vision systems can be used.

When the saw chain 4 is placed in the sharpening device, the device must be informed of the chain's type, so that the device can set the grinding disc 12 to the correct sharpening attitude. The chain's type can be expressed by, for instance, by a code attached to the chain, with the aid of machine vision, by an RFID chip, or the operator can enter the chain type in the device. Next, the device adjusts the grinding disc's 12 angle of tilt relative to the chain's 4 longitudinal axis in the direction of the longitudinal axis and the transverse angle in the transverse direction relative to the longitudinal axis. The adjustments can also be made by the operator. The angle of tilt determines the sharpness of the angle of the cutting edge 8 of the cutter 7 (relative to the angle of tilt of the chain) and the transverse angle determines the slant of the cutting edge 8 in the direction of movement of the chain. When the angle are set and the sharpening device has been adjusted, the grinding disc 12 is on the movement arm 13 at a distance from the chain 4 and the cutter being sharpened. The grinding disc 12 is at a slanting attitude, so that the machining edge 16 of the grinding disc 12 on the chain's incoming side (chain direction arrow 11) points in the incoming direction of the chain 4, thus forming an acute angle with the chain's 4 longitudinal axis to the chain's incoming side. When the first cutter 18 to be sharpened—in this case one of the right-hand cutters when seen against the incoming direction of the chain 4—has been positioned in the sharpening location, the grinding disc 12, pushed by the movement arm 13, makes a straight movement parallel to the angle of tilt towards the first cutter 18 to be sharpened. When grinding disc's 12 machining edge 16 strikes the first cutter 18 to be sharpened, the machining edge 16 cuts material from the cutting edge 8 of the first cutter to be sharpened, thus sharpening the cutter. The movement of the grinding disc 12 continues until the cutting edge 8 has been machined, after which the grinding disc 12 makes a return movement on the movement arm 13. Once the grinding disc has moved away from in front of the first cutter 18 to be sharpened, the chain 4 can be moved in the direction of its longitudinal axis. The movement can be made forwards or backwards. Once the grinding disc 12 has returned to its initial position, it is turned in the direction of the plane of the grinding disc 12 so that the grinding disc's 12 machining edge 16 in the chain's 4 incoming direction moves over the chain 4 to an equal but opposite angle to that when sharpening the first cutter 18 to be sharpened. Thus, the grinding disc's 12 cutting angle, and particularly its direction of rotation remain the same and the grinding disc's direction of rotation need not be changed. The axis of rotation runs through the centre of the grinding disc 12 in its thickness direction and its axis of rotation and machining edge 16 through the corresponding surface of the chain.

Retaining the direction of rotation of the sharpener, particularly the grinding disc, brings several advantages. Changing direction takes time with braking and acceleration and thus reduces productivity. If the disc always rotates according to the angle of the edge of the cutter, the same direction of rotation can be maintained in the disc and both sides of the disc can be used for sharpening. Particularly for a stone disc, this brings the advantage that the disc withstands much more wear when it rotates the whole time in the same direction. The microstructure of the grinding surface of the sharpener always changes according to the machining direction, so that when the direction changes, the roughness of the surface is opposite to the machining direction, so that wear is greater. This is obvious, for example, in stone and ceramic materials. Accelerating and de-accelerating the sharpener also stresses the sharpener and may lead to it breaking.

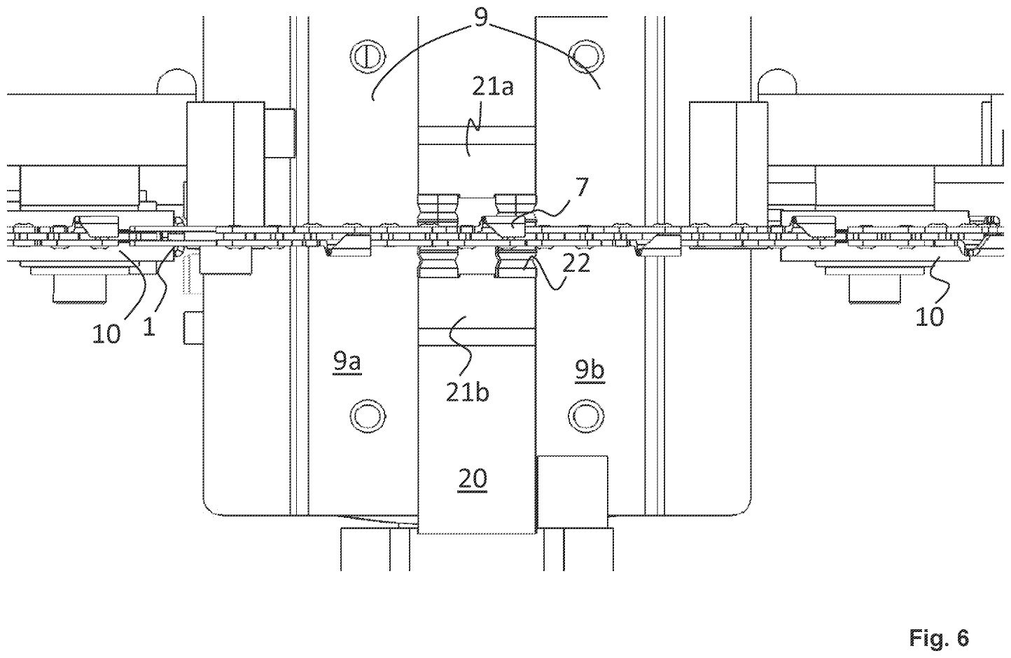

FIG. 6 shows a top view of the sharpening table 9. The idlers 10 are at both sides of the sharpening table 9 and a saw chain set to be sharpened runs through the idlers and over the sharpening table 9. In middle of the sharpening table 9 is a groove 20, which divides the sharpening table 9 into two halves 9a and 9b. In this groove 20 are two vice jaws 21a and 21b, at the ends of which are gripping pads 21a and 21b. The gripping pads 21a, 21b are arranged to move synchronically with each other, thus moving in pace when closing. Thus they press together at the longitudinal centre point of the groove 20, where the saw chain 1 set to be sharpened runs. The gripping pads 22 of the vice jaws 21a, 21b are arranged to grip the protrusion of the chain's drive link 3. Thanks to the jaws' 21a, 21b synchronic movement and the moving compression taking place from both sides, the chain always positions at the same point in the sharpening table 9 and the grinding disc's 12 machining edge 16 strikes the cutter correctly. Such a centring locking of the chain 4 compensates for the differences in width of different types and sizes of chain, which can be so great that otherwise the sharpening of the cutter could vary on the different sides of the chain. The thickness of drive links 3 varies from 1.6 mm to 2.00 mm and, if there way no centring, a separate adjustment would need to be made mechanically for each chain. Of course, such an adjustment would be possible, but it would reduce the degree of automation and could slow operation.

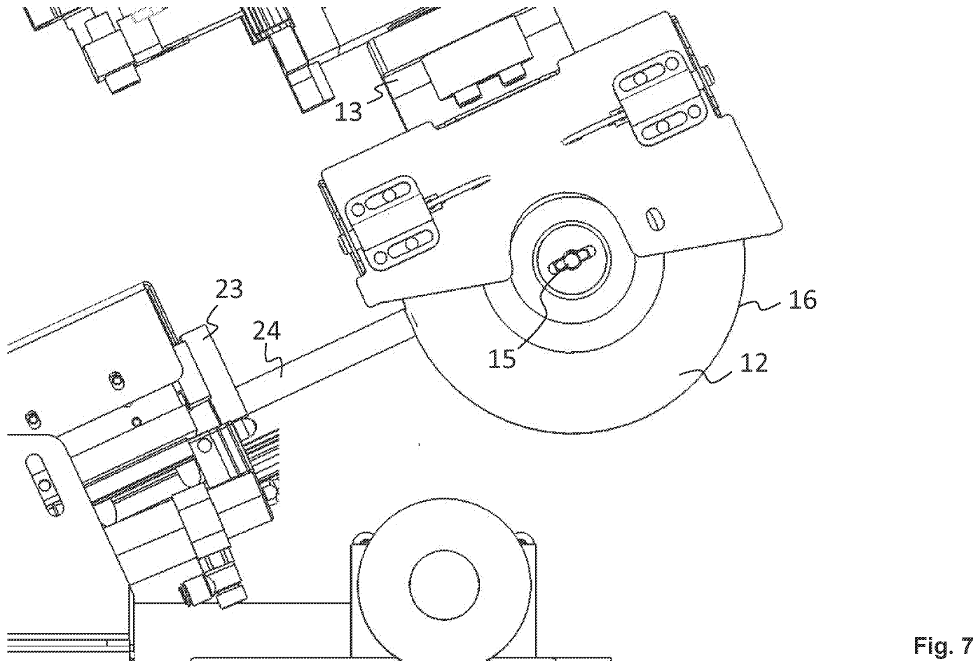

FIG. 7 shows the measurement of the grinding disc. In this example, measurement takes place using a mechanical sensor 23, the measuring head 24 of which is pressed against the machining edge 16 of the grinding disc 12. Alternatively, measurement can take place, for instance, using a laser or other optical sensor. For measurement the grinding disc can be turned to a special measuring attitude, in which it is parallel to the movement of the measuring head. When using a mechanical measuring head, a separate measuring period is needed, but when using a laser or machine-vision, measurement can be continuous. However, there can be little need for continuous measurement. Measurement can take place when required, at regular intervals, or continuously. Measurement of the grinding disc 12 permits truly precise and cost-effective sharpening of the cutters 7 of a chain 4. If the chain 4 has become blunt normally, it will be enough to machine the cutter to be sharpened by removing even as little as less than half a millimetre. Commercially available sharpening machines have mechanical adjustment and the grinding disc cannot be measured, making adjustment of the sharpening of the chain truly imprecise. Existing sharpening machines easily take 2-5 millimetres of material at a time from the chain's cutters, because adjustment is truly imprecise. This shortens the service life of the chain.

Measurement also permits the circumferential velocity of the grinding head to be kept constant and optimal when the circumference of the grinding disc diminishes due to wear. By measuring the diameter/radius of the grinding disc, the speed of rotation of the motor of the sharpening machine's grinding disc can always be adjusted correctly. If the dimension of the circumference of the grinding disc or other sharpening tool is known, its speed of rotation can be adjusted. Normally this happens by the speed being increased when the circumferential dimension diminished. Thus the speed of the machining surface is kept constant, the machining speed is constant and the cutting effect, i.e. the amount of material machined in a period of time, remains constant. Thus the sharpening of each cutter remains identical and constant, irrespective of the wear of the sharpening tool.

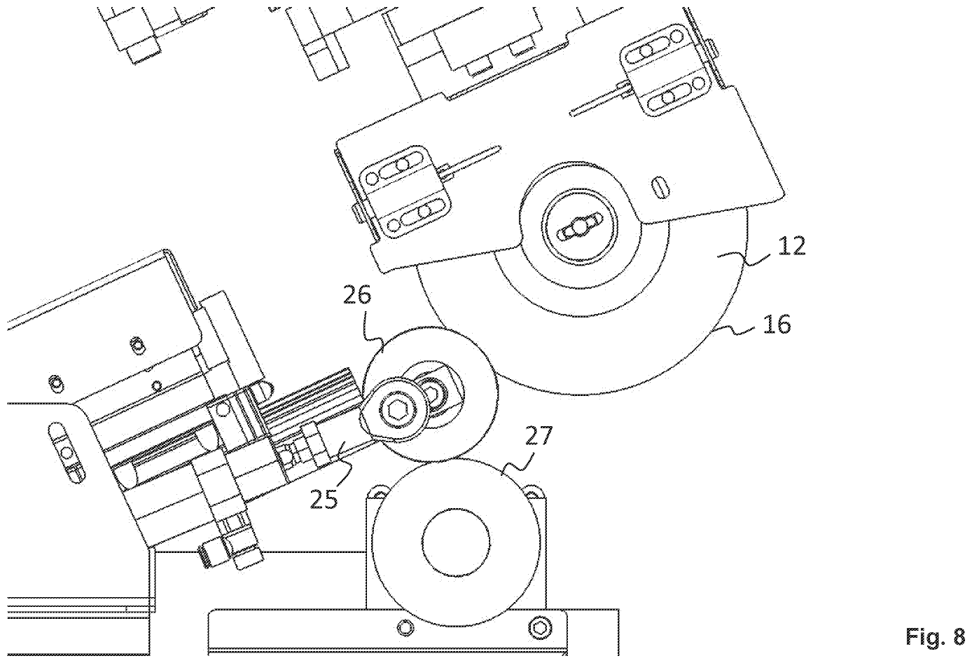

FIG. 8 shows the shaping of the machining edge of the grinding disc 12. Shaping may be necessary when the grinding disc wears or if it is wished to change the shape of the machining edge 16 to sharpen different kinds of cutter. Shaping takes place by pressing the shaping tool 26 at the end of the pushing arm 25 out and against the machining edge 16 of the grinding disc 12, or correspondingly the grinding disc 12 can be pressed against the shaping tool 26. If necessary, the shaping tool 26 can be rotated and supported on a support roller 27. Shaping takes place by rotating the grinding disc 12 and the shaping tool 26. The grinding disc is shaped to an optimal form and adjusted correctly by measuring.

The operator of the sharpening machine can define how much material is removed from the cutter and thus optimize the service life of the saw chain. Optimization can be done automatically or with the aid of machine vision. The condition of the chain can also be checked with the aid of machine vision, in which the need for sharpening and other possible maintenance measures is determined and if necessary the chain can be rejected as being beyond repair.

The saw chain can be brushed to remove burr, metal particles, and cutting oil. Brushing can take place, for instance, by a rotating brush on top of the chain, underneath it, or on one side or the other, or even as a combination of these using several brushes.

A machine-vision system can be installed in the sharpening machine, by which will be obtained, for example, many of the functions and advantages described in the above text. Similarly, service robots can be used in the sharpening machine and method to implement various functions, particularly to set the chain to be sharpened in place for sharpening and to remove the sharpened chain.

Features of the above invention can be combined mutually to form different embodiments and devices. The following is a description of additional alternatives, which can be used together with parts of the above embodiments or steps in the method or as alternatives to them.

Instead of the alternate sharpening described above, the sharpening machine's work cycle can be implemented in such a way that first the cutters of one side of the chain are sharpened and then the cutters of the opposite side, after turning the grinding disc. In principle, the grinding disc can be rotated in either direction, but if the machining direction if inwards from the point of the cutting edge of the cutter, burr will not arise so easily on the point of the cutting edge. The same applies to other sharpeners too. It is economical to use a stone or ceramic disc as the grinding disc due to their cheaper price, but on the other hand a diamond disc, for example, is more expensive to buy, but more durable. It is best to optimize the choice of a suitable disc according to the intended use.

Instead of a turnable disc, two discs or round files or a combination of them working of both sides of the chain can be used. A round file can also be used in a turnable form, as can, for example, the grinding disc described in the example. If two sharpeners working on different sides of the chain are used, they will process the cutters on the same side without stopping the rotation.

### INDUSTRIAL APPLICABILITY

The invention is suitable for the maintenance of the saw chains of chain saws.

### LIST OF REFERENCE NUMBERS

1 tie strap
2 rivet
3 drive piece
4 saw chain
5 cutting plate
6 depth gauge
7 cutter
8 cutting edge
9 sharpening table, halves 9a, 9b
10 idler
11 saw-chain direction arrow
12 grinding disc
13 movement arm
14 motor unit
15 shaft
16 machining edge
17 rotation-direction arrow
18 first cutter to be sharpened
19 second cutter to be sharpened
20 groove
21 vice jaws 21a, 21b
22 gripping pads 22
23 mechanical sensor
24 measuring head
25 pushing arm
26 shaping tool
27 support roller

1. Method A method for sharpening a saw chain, the method comprising:
in a first sharpening stage, contacting a rotating sharpener with a first cutter to be sharpened of the saw chain and pressing the rotating sharpener against the first cutter at a set sharpening angle to remove material from a cutting edge of the first cutter,
moving the saw chain in the direction of its longitudinal axis to position a second cutter of the saw chain for sharpening,
in a second sharpening stage, maintaining rotation of the rotating sharpener is in the same direction as in the first stage and contacting the rotating sharpener with the second cutter to be sharpened to remove material from a cutting edge of the second cutter.

2. The method according to claim 1, wherein:
the rotating sharpener is a grinding disc, which is rotated in the same direction during the sharpening of the first and second cutters,
the saw chain is moved in the direction of the longitudinal axis of the saw chain,
the grinding disc is adjusted to a set sharpening angle, so that grinding disc extends at a slant over the saw chain, and
the grinding disc is turned for sharpening the first and second cutters, so that the edge of the grinding disc on an incoming side of the chain turns over the chain to the other side of the chain and to the side of the incoming direction of the chain.

3. The method according to claim 1, wherein the cutters of the saw chain are sharpened using a sharpener on both sides of the saw chain relative to its longitudinal direction, by which the cutters on the same side as the sharpener are sharpened.

4. The method according to claim 1, wherein the sharpener comprises a grinding disc or a round file, is used as the sharpener.

5. The method according to claim 1, wherein the sharpener is a grinding disc in which the diameter of the disc is measured when necessary, at regular intervals, or continuously.

6. The method according claim 1, wherein the saw chain is gripped in order to secure the chain for the duration of machining the first cutter, using two vice jaws moving relative to each other, between which the chain is pressed.

7. The method according to claim 4, in which wherein the machining edge of the grinding disc is shaped using a shaping tool.

8. A device for sharpening a saw chain, comprising:
a rotating sharpener for sharpening the saw chain,
a moving device configured for bringing the rotating sharpener against a first cutter to be sharpened and for pressing it against this first cutter at a set sharpening angle in order to remove material from a cutting edge of the first cutter in a first stage,
an operating device for moving the saw chain in the direction of its longitudinal axis, in order to position a second cutter of the saw chain for sharpening,
an operating device for keeping the rotating sharpener rotating in the same direction as in the first stage, and
a transfer device for bringing the rotating sharpener at a set angle against the second cutter to be sharpened, in order to remove material from the cutting edge of the second cutter.

9. The device according to claim 8, comprising:
a grinding disc as the rotating sharpener, to which there is connected an operating device for rotating the grinding disc in the same direction during the sharpening of the first and second cutters,
an operating device for moving the saw chain in the direction of the longitudinal axis of the chain,
a transfer device for adjusting the grinding disc to a set sharpening angle, so that the grinding disc extends at a slant over the chain, and
a transfer device configured for turning the grinding disc for the sharpening of the first and second cutters in such a way that the edge of the grinding disc on the side of the incoming direction of the chain turns over the chain to the other side of the chain and to the side of the incoming direction of the chain.

10. The device according to claim 8, further comprising sharpeners on each side of the saw chain relative to its longitudinal direction, in order to sharpen the cutters of the same side as the sharpener.

11. The device according to claim 10, wherein the sharpeners comprise a grinding disc or a round file.

12. The device according to claim 10, wherein at least one sharpener is a grinding disc and further comprising a measuring device for measuring the diameter of the disc.

13. The device according to claim 8, further comprising two vise jaws movable relative to each other, between which the saw chain can be pressed.

14. The device according to claim 11, further comprising a shaping tool for shaping a machining edge of the grinding disc.
